(19) United States
(12) Patent Application Publication
(10) Pub. No.: US 2026/0022137 A1
(43) Pub. Date: Jan. 22, 2026

(54) METHOD FOR PREPARING CYCLIC PHOSPHATE COMPOUND AND DERIVATIVE THEREOF

(71) Applicant: Peking University, Beijing (CN)

(72) Inventors: Wenxiong Zhang, Beijing (CN); Xinlei Huangfu, Beijing (CN); Junnian Wei, Beijing (CN); Zhenfeng Xi, Beijing (CN)

(21) Appl. No.: 19/258,818

(22) Filed: Jul. 2, 2025

(30) Foreign Application Priority Data
Jul. 17, 2024 (CN) 202410960767.2
Sep. 24, 2024 (CN) 202411334521.0

(51) Int. Cl. C07F 9/6571

(52) U.S. Cl. CPC C07F 9/657127

(57) ABSTRACT

Provided is a method for preparing a cyclic phosphate compound represented by formula (III) or formula (IV) and a derivative thereof. The method includes: step 1), adding a compound of formula (I), a compound of formula (II), and a solvent to a reactor, and then adding white phosphorus and a first base in sequence, followed by heating while stirring to obtain a mixed solution of reactants; and step 2), adding a second base to the mixed solution of reactants, and subjecting a resulting mixture to heating and reaction; at end of the reaction, stopping the heating and then cooling a resulting reaction product to room temperature; and adding an acid to the reactor and conducting acidification to obtain a compound of formula (III) or a compound of formula (IV).

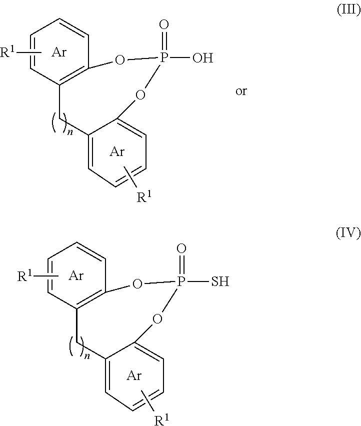

### CROSS REFERENCE TO RELATED APPLICATION(S)

This patent application claims the benefit and priority of Chinese Patent Application No. 202411334521.0 filed with the China National Intellectual Property Administration on Sep. 24, 2024, and Chinese Patent Application No. 202410960767.2 filed with the China National Intellectual Property Administration on Jul. 17, 2024, the contents of each of which are incorporated by reference herein in their entirety as part of the present application.

### TECHNICAL FIELD

The present disclosure relates to the field of organophosphorus chemical industry, and in particular to a method for preparing a cyclic phosphate compound containing a diaryl structural unit and derivatives thereof.

### BACKGROUND

It is well known that organic phosphate compounds are widely used in agriculture, pharmaceutical chemistry, organic synthesis, and other fields. Methods for synthesis of cyclic phosphates and derivatives thereof involve the synthesis of a variety of chiral phosphates and derivatives thereof. Due to the fact that such cyclic phosphates could induce the synthesis of chiral compounds, they have become commonly used catalysts in the field of organic catalytic synthesis and play a very important role in the field of chiral catalysis. However, the conventional synthesis of cyclic phosphates still requires the reaction of corresponding phenol with phosphorus oxychloride and subsequent hydrolysis. Phosphorus oxychloride is a very reactive chemical reagent that is highly sensitive to water. Therefore, it is necessary to react white phosphorus and chlorine gas to form phosphorus trichloride, followed by oxidation of the phosphorus trichloride to produce phosphorus oxychloride (see non-patent document 1). In addition, the reaction of phosphorus oxychloride with phenol is accompanied by the production of a large amount of acid, which consequently requires the addition of a large amount of base for neutralization, leading to the production of a large amount of solid hydrochloride and thus adversely affecting the environment. Therefore, from the perspective of the requirements for modern chemical processes, it is imperative to develop an environmentally friendly and cost-effective method for synthesizing cyclic phosphate compounds and derivatives thereof, which eliminates the need for conventional processes using chlorine gas.

### Prior Art Documents

Non-patent document 1: Donath, M.; Schwedtmann, K.; Schneider, T.; Hennersdorf, F.; Bauzá, A.; Frontera, A.; Weigand, J. Direct Conversion of White Phosphorus to Versatile Phosphorus Transfer Reagents via Oxidative Onioation. Nat. Chem. 2022, 14, 384-391.

### SUMMARY

### Technical Problem to be Solved by the Present Disclosure

The present disclosure has been made in view of the above problems. An object of the present disclosure is to provide a method for efficiently synthesizing a cyclic phosphate compound containing a diaryl structural unit and derivatives thereof, which is not only environmentally friendly but also cost-effective.

### Solutions to Solve the Problems

The present disclosure provides the following technical solutions:

The present disclosure provides a cyclic phosphate compound and a derivative thereof, the cyclic phosphate compound being a compound of formula (III) or a compound of formula (IV) each containing a diaryl structural unit:

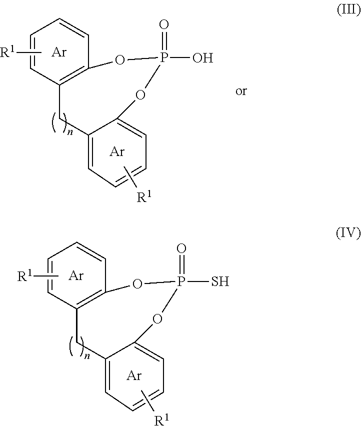

where in the formula (III) or the formula (IV), R¹ represents one selected from the group consisting of hydrogen, halogen, alkenyl, nitro, cyano, trifluoromethyl, trifluoromethoxy, alkyl, alkoxy, substituted or unsubstituted phenyl, substituted or unsubstituted biphenyl, naphthyl, anthracenyl, phenanthrenyl, pyridyl, thienyl, a benzo group, etc.; Ar represents one selected from the group consisting of an aromatic ring group such as phenyl, naphthyl, anthracenyl, phenanthrenyl, pyridyl, and thienyl; and n represents carbon number and is an integer of 0 or greater than 0, preferably an integer of 0 to 4, and more preferably 0 or 1.

In some embodiments, the alkyl group mentioned above is a C1-C10 alkyl group, and the alkyl group is methyl, ethyl, propyl, isopropyl, butyl, isobutyl, pentyl, hexyl, heptyl, isopentyl, etc.; the alkoxy group mentioned above is a C1-C10 alkoxy group, and the alkoxy group is methoxy, ethoxy, propoxy, butoxy, pentyloxy, hexyloxy, heptyloxy, etc.; the Ar is an aromatic ring group such as phenyl, naphthyl, anthracenyl, and phenanthrenyl; and
in the above-mentioned substituted phenyl or substituted biphenyl, the substitution is mono-or poly-substituted, in which case the substituent in the substituted phenyl or substituted biphenyl is an alkyl group (in particular methyl, ethyl, and propyl), an alkoxy group (in particular methoxy, ethoxy, propoxy, and butoxy), halogen (in particular chlorine and bromine), nitro, phenyl, etc.

In some embodiments, in the formula (III) or the formula (IV), the R¹ represents one selected from the group consisting of hydrogen, fluorine, chlorine, bromine, allyl, nitro, cyano, trifluoromethyl, methyl, ethyl, propyl, isopropyl, methoxy, ethoxy, phenyl, tolyl, trimethylphenyl, nitrophenyl, chlorophenyl, bromophenyl, biphenyl, methylbiphenyl, naphthyl, anthracenyl, and phenanthryl, and the Ar represents phenyl or naphthyl.

A method for preparing a cyclic phosphate compound and a derivative thereof, the cyclic phosphate compound being a compound of formula (III) or a compound of formula (IV) each containing a diaryl structural unit, the method including the following steps:

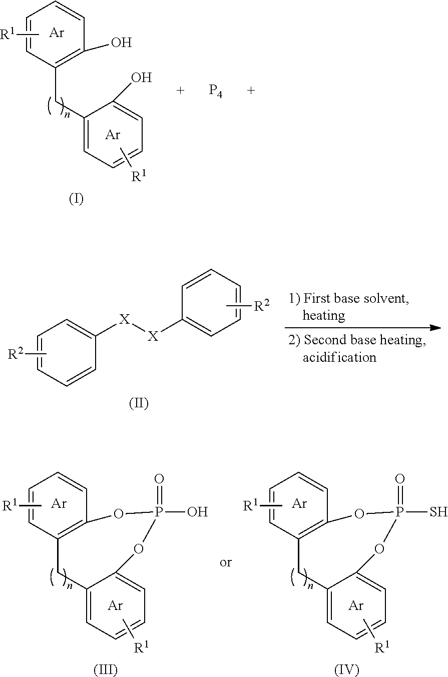

step 1): adding a compound of formula (I), a compound of formula (II), and a solvent to a reactor, and after dissolving same, adding white phosphorus and a first base in sequence, followed by heating while stirring to obtain a mixed solution of reactants; and
step 2): adding a second base to the mixed solution of reactants obtained in step 1), and subjecting a resulting mixture to heating and reaction; at end of the reaction, stopping the heating and then cooling a resulting reaction product to room temperature; and adding an acid to the reactor and conducting acidification to obtain the compound of formula (III) or the compound of formula (IV).

In the present disclosure, in the formula (II): R² represents hydrogen, halogen, alkenyl, nitro, cyano, trifluoromethyl, trifluoromethoxy, alkyl, alkoxy, substituted or unsubstituted phenyl, substituted or unsubstituted biphenyl, naphthyl, anthracenyl, phenanthrenyl, pyridyl, thienyl, a benzo group, etc.

In some embodiments, in the R^{2,} the alkyl group is a C1-C10 alkyl group, and the alkyl group is methyl, ethyl, propyl, isopropyl, butyl, isobutyl, pentyl, hexyl, heptyl, isopentyl, etc.; the alkoxy group is a C1-C10 alkoxy group, and the alkoxy group is methoxy, ethoxy, propoxy, butoxy, pentyloxy, hexyloxy, heptyloxy, etc.; and Ar is an aromatic ring group such as phenyl, naphthyl, anthracenyl, and phenanthrenyl.

In some embodiments, the substituted or unsubstituted phenyl and the substituted or unsubstituted biphenyl each have the same meanings as the definition given above for R¹.

In some embodiments, the first base used in step 1) is selected from the group consisting of a hydroxide, a carbonate, a phosphate or an organic alkoxide of an alkali metal, and an organic amine. In some embodiments, the first base is the organic amine (e.g., triethylamine, diethylamine, etc.) or the hydroxide of the alkali metal (e.g., sodium hydroxide, and potassium hydroxide).

In some embodiments, the solvent used in the reaction needs to contain dialkyl sulfoxide, which is a solvent of dialkyl sulfoxide alone or a mixture thereof with other solvents in a volume ratio of 100:1 to 0:1. The other solvent may be any organic solvent as long as it does not react with the compound of formula (I), the compound of formula (II), white phosphorus and dialkyl sulfoxide, for example, acetonitrile (MeCN), tetrahydrofuran (THF), diethyl ether (Et₂O), acetone, benzene, toluene, 1,4-dioxane, dimethoxyethane (DME), or tetramethylethylenediamine (TMEDA). In some embodiments, the solvent is dimethyl sulfoxide (DMSO) alone or a mixed solvent of dimethyl sulfoxide and the other solvents. In some embodiments, dimethyl sulfoxide (DMSO) is used alone.

In some embodiments, in step 1), the heating is conducted at a temperature of 40° C. to 120° C. for 2-8 hours. In some embodiments, the heating is conducted at a temperature of 50° C. to 100° C. for 3-6 hours.

In some embodiments, in step 1), a molar amount of the compound of formula (I) and the compound of formula (II) are 1.0-1.5 times and 0.2-2.0 times a molar equivalent of phosphorus atoms in the white phosphorus (P₄), respectively, and a molar amount of the first base is 0.2-2.0 times the molar equivalents of the phosphorus atoms in the white phosphorus (P₄). In some embodiments, the molar amount of the compound of formula (I) is 1.0-1.4 times the molar equivalent of the phosphorus atoms in the white phosphorus, and the molar amount of the compound of formula (II) is 0.4-0.9 times the molar equivalent of the phosphorus atoms in the white phosphorus.

In some embodiments, in step 2), the second base for synthesis of the compound of formula (III) is selected from the group consisting of a hydroxide, a carbonate, a phosphate or an organic alkoxide of an alkali metal, and an organic amine, where the alkali metal is potassium or sodium; and potassium hydroxide is preferred. The second base for synthesis of the compound of formula (IV) is selected from the group consisting of sodium hydrosulfide, potassium hydrosulfide, sodium sulfide, and ammonium sulfide, preferably sodium hydrosulfide.

In some embodiments, the acid used for the acidification in step 2) is a strong inorganic acid, such as sulfuric acid (H₂SO₄), nitric acid (HNO₃), hydrochloric acid (HCl), perchloric acid (HClO₄), permanganic acid (HMnO₄), hydroiodic acid (HI), and hydrobromic acid (HBr), preferably hydrochloric acid (HCl) or hydrobromic acid (HBr).

In some embodiments, in step 2), the heating is conducted at a temperature of room temperature to 120° C., preferably 60° C. to 80° C. for 2-8 hours, preferably 2-5 hours.

In some embodiments, in step 2), the acidification is conducted at room temperature for 0.5-4 hours, preferably 1-3 hours.

In some embodiments, in step 2), a molar amount of the second base is in a range of 1.0-2.5 times, preferably 1.5-2.0 times, a molar equivalents of phosphorus atoms in the white phosphorus (P₄) in step 1).

In some embodiments, in step 2), an amount of the acid is controlled according to pH, and the acidification is conducted until a resulting acidification system has a pH of 1-3.

### Effects

According to the present disclosure, provided is a method for synthesizing a cyclic phosphate compound and derivatives thereof via a one-pot process using white phosphorus. The conventional synthesis process requires multiple complex reactions, for example, first a reaction of white phosphorus with chlorine gas to obtain a phosphorus trichloride intermediate, and then a reaction of phosphorus trichloride with a base material of diaryl phenols, followed by acidolysis to give a cyclic phosphate compound. By contrast, the method of the present disclosure does not require the use of phosphorus trichloride, avoids the problem of using very highly polluting chlorine gas and the generation of a large amount of acid in conventional phosphoric chemical production, and is more environmentally friendly with simple reaction steps.

The cyclic phosphate (such as phosphate with a chiral binaphthol backbone) and derivatives thereof synthesized by the method of the present disclosure have a wide applications in the field of organic synthesis, especially in the field of asymmetric catalytic synthesis, and are a class of compounds of important value. Compared with conventional synthesis routes, the method of the present disclosure shows mild reaction conditions, short reaction time, and simple workup procedures, while resulting in high yields.

### DETAILED DESCRIPTION OF EMBODIMENTS

The foregoing summary of the present disclosure is described in further detail below by way of specific embodiments, which, however, should not be construed as limiting in any way the scope of the present disclosure. All technical solutions realized based on the content of the present disclosure described above are within the scope of the present disclosure. The present disclosure provides a general and/or specific description of the materials used in the tests and the test methods. It is clear to a person skilled in the art that in the following, if not specifically stated, the room temperature described in the present disclosure has technical meanings known in the art, typically 20° C. to 25° C.; and all of the chemicals described are commercially available.

The present disclosure provides a method for preparing a cyclic phosphate compound and a derivative thereof, the cyclic phosphate compound being a compound of formula (III) or a compound of formula (IV) each containing a diaryl structural unit.

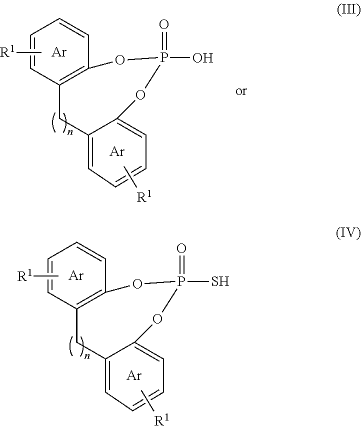

In the present disclosure, in the formula (III) or the formula (IV): R¹ represents hydrogen, halogen, alkenyl, nitro, cyano, trifluoromethyl, trifluoromethoxy, an alkyl group of any carbon number, an alkoxy group of any carbon number, substituted or unsubstituted phenyl, substituted or unsubstituted biphenyl, naphthyl, anthracenyl, phenanthrenyl, pyridyl, thienyl, a benzo group, etc.; Ar represents an aromatic ring group such as phenyl, naphthyl, anthracenyl, phenanthrenyl, pyridyl, and thienyl; and n represents carbon number and is an integer of 0 or greater than 0. In some embodiments, n is 0 or 1.

In some embodiments, the substituted or unsubstituted phenyl and the substituted or unsubstituted biphenyl each have the same meanings as the definition given above.

### Preparation of Compounds

A method for preparing a cyclic phosphate compound includes the following steps:

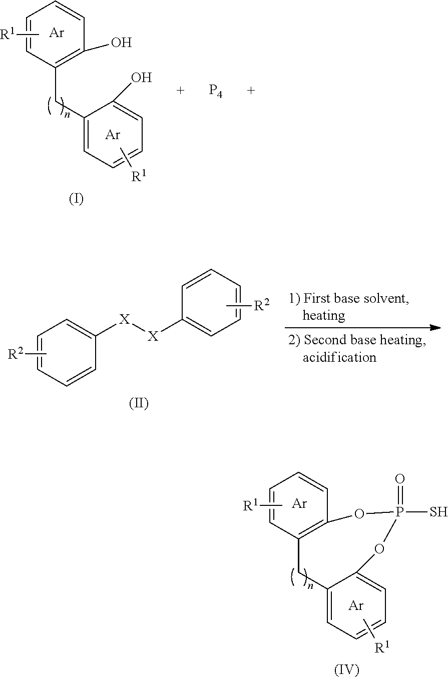

step 1), a compound of formula (I), a compound of formula (II), and a solvent are added to a reactor, and after dissolving same, white phosphorus and a first base are added in sequence, followed by heating while stirring to obtain a mixed solution of reactants; and
step 2): a second base is added to the mixed solution of reactants obtained in step 1), and a resulting mixture is subjected to heating and reaction; at end of the reaction, the heating is stopped and then a resulting reaction product is cooled to room temperature; and an acid is added to the reactor and acidification is conducted to obtain a compound of formula (III).

A method for preparing a derivative of a cyclic phosphate compound includes the following steps:

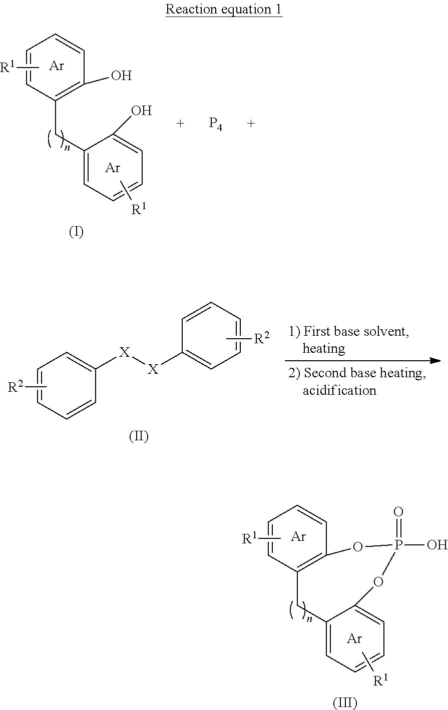

step 1): a compound of formula (I), a compound of formula (II), and a solvent are added to a reactor, and after dissolving same, white phosphorus and a first base are added in sequence, followed by heating and stirring to obtain a mixed solution of reactants; and
step 2): a second base is added to the mixed solution of reactants obtained in step 1), and a resulting mixture is subjected to heating and reaction; at end of the reaction, the heating is stopped and then a resulting reaction product is cooled to room temperature; and an acid is added to the reactor and acidification is conducted to obtain a compound of formula (IV).

In the present disclosure, in both the reaction equations described above, for the compound of formula (I), R¹ represents hydrogen, halogen, alkenyl, nitro, cyano, trifluoromethyl, trifluoromethoxy, alkyl, alkoxy, substituted or unsubstituted phenyl, substituted or unsubstituted biphenyl, naphthyl, anthracenyl, phenanthrenyl, pyridyl, thienyl, etc.; Ar represents an aromatic ring group, such as phenyl, naphthyl, anthracenyl, phenanthrenyl, pyridyl, and thienyl; and n represents carbon number and is an integer of 0 or greater than 0.

In the present disclosure, in the formula (II), X represents S, Se, or Te; and R² represents hydrogen, halogen, nitro, cyano, trifluoromethyl, trifluoromethoxy, alkyl, alkoxy, substituted or unsubstituted phenyl, substituted or unsubstituted biphenyl, naphthyl, anthracenyl, phenanthrenyl, pyridyl, thienyl, etc.

In the present disclosure, in the formula (III) or the formula (IV), R¹ represents hydrogen, halogen, nitro, cyano, trifluoromethyl, trifluoromethoxy, alkyl, alkoxy, substituted or unsubstituted phenyl, substituted or unsubstituted biphenyl, naphthyl, anthracenyl, phenanthrenyl, pyridyl, thienyl, a benzo group etc.; Ar represents an aromatic ring group, such as phenyl, naphthyl, anthracenyl, phenanthrenyl, pyridyl, and thienyl; and n represents carbon number and is an integer of 0 or greater than 0.

In some embodiments, the substituted or unsubstituted phenyl and the substituted or unsubstituted biphenyl each have the same meanings as the definition given above for R¹ and R².

In some embodiments, in step 1) of both the reaction equations described above, the first base is selected from the group consisting of a hydroxide, a carbonate, a phosphate or an organic alkoxide of an alkali metal, and an organic amine, preferably the organic amine.

In some embodiments, the solvent used in both the reaction equations described above needs to contain dialkyl sulfoxide, which is a solvent of dialkyl sulfoxide alone or a mixture thereof with other solvents in a volume ratio of 100:1 to 0:1. The other solvent may be any organic solvent as long as it does not react with the compound of formula (I), the compound of formula (II), white phosphorus, and dialky sulfoxide, for example, acetonitrile (MeCN), tetrahydrofuran (THF), diethyl ether (Et₂O), acetone, benzene, toluene, 1,4-dioxane, dimethoxyethane (DME), or tetramethylethylenediamine (TMEDA). Preferably, the solvent is dimethyl sulfoxide (DMSO) alone.

In some embodiments, in step 1) of both the reaction equations described above, the heating is conducted at a temperature of 40° C. to 120° C. for 2-8 hours.

In some embodiments, in step 1) of both the reaction equations described above, a molar amount of the compound of formula (I) and the compound of formula (II) is in a range of 1.0-1.5 times and 0.2-2.0 times a molar equivalent of the white phosphorus (P₄), respectively, and a molar amount of the first base is 0.2-2.0 times the molar equivalents of the white phosphorus (P₄).

In some embodiments, in step 2), the second base for synthesis of the compound of formula (III) is selected from the group consisting of a hydroxide, a carbonate, a phosphate or an organic alkoxide of an alkali metal, and an organic amine, where the alkali metal is potassium or sodium; and potassium hydroxide is preferred. The second base for synthesis of the compound of formula (IV) is selected from the group consisting of sodium hydrosulfide, potassium hydrosulfide, sodium sulfide, and ammonium sulfide, preferably sodium hydrosulfide.

In some embodiments, the acid used for the acidification in step 2) of both the reaction equations described above is a strong inorganic acid, such as sulfuric acid (H₂SO₄), nitric acid (HNO₃), hydrochloric acid (HCl), perchloric acid (HClO₄), permanganic acid (HMnO₄), hydroiodic acid (HI), and hydrobromic acid (HBr), preferably hydrochloric acid (HCl) or hydrobromic acid (HBr).

In some embodiments, in step 2) of both the reaction equations described above, after adding the second base, the reaction is conducted at a temperature of room temperature to 120° C., preferably 60-80° C., and the reaction is conducted for 1-8 hours, preferably 2-5 hours.

In some embodiments, in step 2) of both the reaction equations described above, in the acidification step, the acidification is conducted at room temperature, and the acidification is conducted for 0.5-4 hours, preferably 1-3 hours.

In some embodiments, in step 2) of both the reaction equations described above, a molar amount of the second base is in a range of 1.0-2.5 times, preferably 1.5-2.0 times, a molar equivalents of the white phosphorus (P₄) in step 1).

In some embodiments, in step 2) of both the reaction equations described above, an amount of the acid is controlled according to pH, and the acidification is conducted until a resulting acidification system has a pH of 1-3.

In some embodiments, the solvents used in the steps 1) of both the reaction equations described above may be the same or different. For ease of operation and workup, it is preferable to carry out the operation of step 2) directly in the reaction solution of step 1) without the need for purification and separation of the reaction product of step 1).

As can be seen from the methods described above, the method disclosed in the present disclosure shows mild reaction conditions, relatively short reaction time, and simple workup operations (as can be known from the reaction operations in the examples below), while resulting in high yields.

The method for preparing the compounds described above is described in detail in the following examples.

### Synthesis of a Compound of Formula (III) or Formula (IV)

### Example 1: Synthesis of (S)-3,3′-dimethyl-1,1′-binaphthol Hydrogen Phosphate

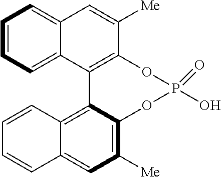

In a glove box filled with nitrogen, (S)-3,3′-dimethyl-[1,1′-binaphthylyl]-2,2′-diphenol (0.33 mmol), diphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atoms, dissolved in 320 μL toluene) and Et₃N (0.06 mmol) were added thereto in sequence. A resulting reaction mixture was stirred at 80° C. for 4 hours, then KOH (0.6 mmol) was added thereto and alkaline hydrolysis was continued at 80° C. for 3 hours. At the end of reaction, dichloromethane and a 4 M dilute hydrochloric acid solution were added and subjected to acidification until a resulting acidification system had a pH of 3, and a resulting organic phase was extracted several times. A resulting combined organic phases were evaporated to dryness on a rotary evaporator and then a resulting crude reaction mixture was purified by flash chromatography to obtain a product in 90% yield (yield calculated on phosphorus atoms).

Main nuclear magnetic resonance (NMR) data: ¹H NMR (500 MHZ, CD3OD): δ 2.67 (s, 6H), 7.13-7.18 (m, 4H), 7.35-7.39 (m, 2H), 7.83-7.85 (m, 4H); ¹³C NMR (150 MHZ, CD3OD): δ 18.0, 123.4, 125.9, 126.2, 127.7, 128.7, 130.8, 132.0, 132.7, 149.7 (d, J=9.5 Hz); 31P NMR (243 MHz, CD3OD): δ 2.4; HRMS calcd for [C22H1704P] ([M+H]⁺): 377.0938, found 377.0937.

### Example 2: Synthesis of (Rac)-binaphthol Hydrogen Phosphate

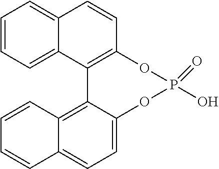 [SMILES: O=P1(O)Oc2ccc3ccccc3c2-c2c(ccc3ccccc23)O1]

In a glove box filled with nitrogen, (Rac)-binaphthol (0.36 mmol), diphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 3 hours, then KOH (0.6 mmol) was added thereto and alkaline hydrolysis was continued at 80° C. for 2 hours. At the end of reaction, dichloromethane and a 4 M dilute hydrochloric acid solution were added and subjected to acidification until a resulting acidification system had a pH of 2, and a resulting organic phase was extracted several times. A resulting combined organic phases were evaporated to dryness on a rotary evaporator and then a resulting crude reaction mixture was purified by flash chromatography to obtain a product in 91% yield (yield calculated on phosphorus atoms).

Main NMR data: ¹H NMR (600 MHZ, CD₃OD): δ 7.30-7.34 (m, 4H), 7.50-7.53 (m, 2H), 7.58 (d, J=8.9 Hz, 2H), 8.03 (d, J=8.4 Hz, 2H), 8.13 (d, J=8.9 Hz, 2H); ¹³C NMR (150 MHz, CD₃OD): δ121.8, 122.8, 126.7, 127.8, 129.7, 132.3, 133.1, 133.6, 148.8 (d, J=9.7 Hz); ³¹P NMR (243 MHZ, CD₃OD): δ 3.7; HRMS calcd for [C₂₀H₁₃O₄P] ([M+H]⁺): 349.0625, found 349.0628.

### Example 3: Synthesis of (R)-3,3′-dimethoxy-1,1′-binaphthol Phosphate

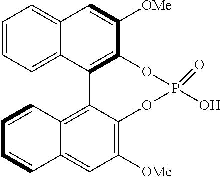

In a glove box filled with nitrogen, (R)-3,3′-dimethoxy-[1,1′-binaphthylyl]-2,2′-diphenol (0.33 mmol), diphenyl diselenide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 60° C. for 5 hours, then KOH (0.6 mmol) was added and alkaline hydrolysis was continued at 70° C. for 4 hours. At the end of reaction, dichloromethane and a 4 M dilute hydrochloric acid solution were added and subjected to acidification until a resulting acidification system had a pH of 3, and a resulting organic phase was extracted several times. A resulting combined organic phases were evaporated to dryness on a rotary evaporator and then a resulting crude reaction mixture was purified by flash chromatography to obtain a product in 82% yield (yield calculated on phosphorus atoms).

Main NMR data: ¹H NMR (500 MHZ, CD₃OD): δ 4.03 (s, 6H), 7.03-7.13 (m, 4H), 7.35 (t, J=7.5 Hz, 2H), 7.53 (s, 2H), 7.84 (d, J=8.3 Hz, 2H); ¹³C NMR (125 MHz, CD₃OD): δ 56.6, 109.9, 124.2 (d, J=2.7 Hz), 125.3, 127.2, 127.7, 128.0, 128.5, 133.6, 140.3 (d, J=9.2 Hz), 151.6 (d, J=2.7 Hz); ³¹P NMR (202 MHZ, CD₃OD): δ 3.5; HRMS calcd for [C₂₂H₁₇O₆P] ([M+H]⁺): 409.0836, found 409.0836.

### Example 4: Synthesis of (R)-3,3′-diphenyl-1,1′-binaphthol Hydrogen Phosphate

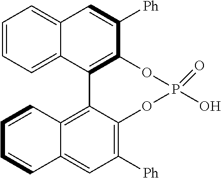

In a glove box filled with nitrogen, (R)-3,3′-diphenyl-[1,1′-binaphthylyl]-2,2′-diphenol (0.33 mmol), diphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 5 hours, then KOH (0.6 mmol) was added thereto and alkaline hydrolysis was continued at 80° C. for 3 hours. At the end of reaction, dichloromethane and a 4 M dilute hydrochloric acid solution were added and subjected to acidification until a resulting acidification system had a pH of 1, and a resulting organic phase was extracted several times. A resulting combined organic phases were evaporated to dryness on a rotary evaporator and then a resulting crude reaction mixture was purified by flash chromatography to obtain a product in 89% yield (yield calculated on phosphorus atoms).

Main NMR data: ¹H NMR (600 MHZ, CD₃OD): δ 7.19-7.25 (m, 4H), 7.31-7.33 (m, 2H), 7.40 (t, J=7.7 Hz, 4H), 7.45 (t, J=7.5 Hz, 2H), 7.77 (d, J=7.6 Hz, 4H), 8.00 (d, J=8.2 Hz, 2H), 8.05 (s, 2H); ¹³C NMR (150 MHz, CD₃OD): δ 124.1, 126.7, 127.5, 127.7, 128.5, 129.2, 129.6, 131.2, 132.2, 132.7, 133.4, 135.6, 139.0, 146.9 (d, J=9.0 Hz); ³¹P NMR (243 MHz, CD₃OD): δ 1.7; HRMS calcd for [C₃₂H₂₁O₄P] ([M+H]⁺): 501.1251, found 501.1253.

### Example 5: Synthesis of (S)-3,3′-dibromo-1,1′-binaphthol Hydrogen Phosphate

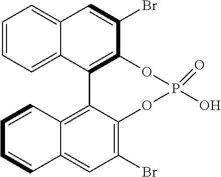

In a glove box filled with nitrogen, (R)-3,3′-dibromo-[1,1′-binaphthylyl]-2,2′-diphenol (0.33 mmol), 4,4′-dichlorodiphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 6 hours, then KOH (0.6 mmol) was added thereto and alkaline hydrolysis was continued at 80° C. for 2 hours. At the end of reaction, dichloromethane and a 4 M dilute hydrochloric acid solution were added and subjected to acidification until a resulting acidification system had a pH of 2, and a resulting organic phase was extracted several times. A resulting combined organic phases were evaporated to dryness on a rotary evaporator and then a resulting crude reaction mixture was purified by flash chromatography to obtain a product in 88% yield (yield calculated on phosphorus atoms).

Main NMR data: ¹H NMR (500 MHZ, CD₃OD): δ 6.98 (d, J=8.6 Hz, 2H), 7.11 (t, J=7.3 Hz, 2H), 7.34 (t, J=7.6 Hz, 2H), 7.80 (d, J=8.3 Hz, 2H), 8.30 (s, 2H); ¹³C NMR (125 MHz, CD₃OD): δ 115.6 (d, J=2.3 Hz), 124.2, 127.5, 127.6, 128.2, 128.8, 132.4, 133.2, 135.0, 145.4 (d, J=9.1 Hz); ³¹P NMR (202 MHZ, CD₃OD): δ 2.2; HRMS calcd for [C₂₀H₁₁Br₂O₄P] ([M+H]⁺): 506.8814, found 506.8822.

### Example 6: Synthesis of (R)-3,3′-bis(4-methoxyphenyl)-1,1′-binaphthol Hydrogen Phosphate

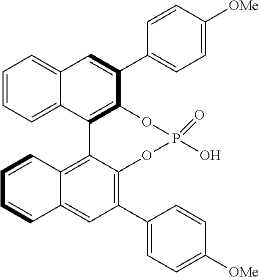

In a glove box filled with nitrogen, (R)-3,3′-bis(4-methoxyphenyl)-[1,1′-binaphthylyl]-2,2′-diphenol (0.33 mmol), 4,4′-difluorodiphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 5 hours, then KOH (0.6 mmol) was added thereto and alkaline hydrolysis was continued at 80° C. for 4 hours. At the end of reaction, dichloromethane and a 4 M dilute hydrochloric acid solution were added and subjected to acidification until a resulting acidification system had a pH of 3, and a resulting organic phase was extracted several times. A resulting combined organic phases were evaporated to dryness on a rotary evaporator and then a resulting crude reaction mixture was purified by flash chromatography to obtain a product in 90% yield (yield calculated on phosphorus atoms).

Main NMR data: ¹H NMR (600 MHz, CDCl₃): δ 3.50 (s, 6H), 6.80 (d, J=7.1 Hz, 4H), 7.22-7.33 (m, 4H), 7.44-7.51 (m, 6H), 7.92 (t, J=8.3 Hz, 4H); ¹³C NMR (150 MHz, CDCl₃): δ 55.1, 113.9, 122.6, 126.0, 126.4, 127.2, 128.4, 129.2, 131.0, 131.2, 131.7, 131.9, 133.8, 144.8 (d, J=8.3 Hz), 159.3; 31P NMR (243 MHZ, CDCl₃): δ 2.6; HRMS calcd for [C₃₄H₂₅O₆P] ([M+H]⁺): 561.1462, found 561.1463.

### Example 7: Synthesis of (R)-3,3′-bis(4-nitrophenyl)-1,1′-binaphthol Hydrogen Phosphate

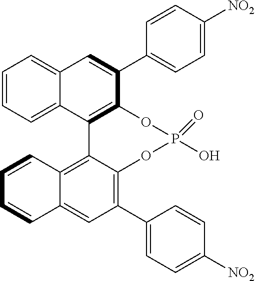

In a glove box filled with nitrogen, (R)-3,3′-bis(4-nitrophenyl)-[1,1′-binaphthylyl]-2,2′-diphenol (0.33 mmol), diphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 6 hours, then KOH (0.6 mmol) was added thereto and alkaline hydrolysis was continued at 80° C. for 2 hours. At the end of reaction, dichloromethane and a 4 M dilute hydrochloric acid solution were added and subjected to acidification until a resulting acidification system had a pH of 2, and a resulting organic phase was extracted several times. A resulting combined organic phases were evaporated to dryness on a rotary evaporator and then a resulting crude reaction mixture was purified by flash chromatography to obtain a product in 84% yield (yield calculated on phosphorus atoms).

Main NMR data: ¹H NMR (600 MHz, CDCl₃/CD₃OD=14:1): δ 7.37 (br, 2H), 7.55 (br, ¹H), 7.81 (br, 2H), 8.00-8.03 (m, 2H), 8.16 (br, 2H); ¹³C NMR (150 MHz, CDCl₃/CD₃OD =14:1): δ 122.9, 123.3, 126.4, 127.0, 127.4, 128.6, 130.8, 131.2, 131.6, 131.8, 132.5, 143.8, 144.3 (d, J=7.2 Hz), 147.1; 31P NMR (243 MHz, CDCl₃/CD₃OD=14:1): δ 1.6; HRMS calcd for [C₃₂H₁₉N₂O₈P] ([M−H]⁺): 589.0806, found 589.0805.

### Example 8: Synthesis of (R)-3,3′-bis(2,4,6-trimethylphenyl)-1,1′-binaphthol Hydrogen Phosphate

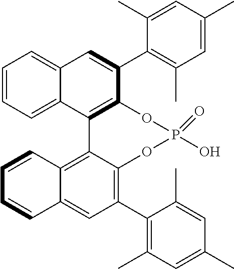

In a glove box filled with nitrogen, (R)-3,3′-bis(2,4,6-trimethylphenyl)-[1,1′-binaphthylyl]-2,2′-diphenol (0.33 mmol), 4,4′-dichlorodiphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 6 hours, then KOH (0.6 mmol) was added thereto and alkaline hydrolysis was continued at 60° C. for 4 hours. At the end of reaction, dichloromethane and a 4 M dilute hydrochloric acid solution were added and subjected to acidification until a resulting acidification system had a pH of 1, and a resulting organic phase was extracted several times. A resulting combined organic phases were evaporated to dryness on a rotary evaporator and then a resulting crude reaction mixture was purified by flash chromatography to obtain a product in 90% yield (yield calculated on phosphorus atoms).

Main NMR data: ¹H NMR (500 MHZ, CDCl₃): δ 1.90 (s, 6H), 2.00 (s, 6H), 2.06 (s, 6H), 6.60 (s, 2H), 6.75 (s, 2H), 7.22-7.33 (m, 4H), 7.42 (t, J=7.4 Hz, 2H), 7.65 (s, 2H), 7.87 (d, J=8.0 Hz, 2H); ¹³C NMR (125 MHz, CDCl₃): δ 20.4, 21.0, 21.3, 122.8, 125.2, 126.1, 127.2, 127.5, 128.1, 128.2, 131.1, 131.2, 132.5, 133.1, 134.8, 137.1, 137.6, 137.9, 146.9 (d, J=10.0 Hz); ³¹P NMR (202 MHZ, CDCl₃): δ 4.3; HRMS calcd for [C₃₈H₃₃O₄P] ([M−H]⁺): 583.2043, found 583.2035.

### Example 9: Synthesis of (S)-6,6′-dibromo-1,1′-binaphthol Hydrogen Phosphate

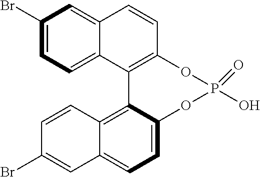

In a glove box filled with nitrogen, (S)-6,6′-dibromo-[1,1′-binaphthylyl]-2,2′-diphenol (0.33 mmol), 4,4′-dibromodiphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 6 hours, then KOH (0.6 mmol) was added thereto and alkaline hydrolysis was continued at 80° C. for 2 hours. At the end of reaction, dichloromethane and a 4 M dilute hydrochloric acid solution were added and subjected to acidification until a resulting acidification system had a pH of 3, and a resulting organic phase was extracted several times. A resulting combined organic phases were evaporated to dryness on a rotary evaporator and then a resulting crude reaction mixture was purified by flash chromatography to obtain a product in 83% yield (yield calculated on phosphorus atoms).

Main NMR data: ¹H NMR (500 MHZ, DMSO-d6): δ 7.14 (d, J=9.0 Hz, 2H), 7.50 (dd, J=9.3 Hz, J=2.0 Hz, 2H), 7.55 (d, J=9.0 Hz, 2H), 8.12 (d, J=8.8 Hz, 2H), 8.36 (d, J=1.8 Hz, 2H); ¹³C NMR (125 MHz, DMSO-d6): δ 118.2, 121.2, 123.2, 128.1, 129.6, 129.9, 130.3, 132.0, 149.2 (d, J=9.5 Hz); ³¹P NMR (202 MHZ, DMSO-d6): δ 3.0; HRMS calcd for [C₂₀H₁₁Br₂O₄P] ([M−H]⁺): 504.8668, found 504.8670.

### Example 10: Synthesis of (R)-VANOL Hydrogen Phosphate

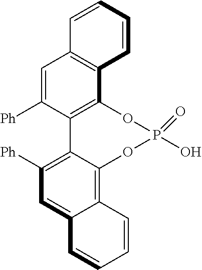

In a glove box filled with nitrogen, (2R)-3,3′-diphenyl [2,2′-binaphthylyl]-1,1′-diol (0.33 mmol), diphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 5 hours, then KOH (0.6 mmol) was added thereto and alkaline hydrolysis was continued at 80° C. for 3 hours. At the end of reaction, dichloromethane and a 4 M dilute hydrochloric acid solution were added and subjected to acidification until a resulting acidification system had a pH of 1.5, and a resulting organic phase was extracted several times. A resulting combined organic phases were evaporated to dryness on a rotary evaporator and then a resulting crude reaction mixture was purified by flash chromatography to obtain a product in 83% yield (yield calculated on phosphorus atoms).

Main NMR data: ¹H NMR (600 MHz, CD₃OD): δ 6.48 (d, J=7.6 Hz, 4H), 6.92 (t, J=7.5 Hz, 4H), 7.10 (t, J=7.3 Hz, 2H), 7.51 (s, 2H), 7.59 (t, J=7.3 Hz, 2H), 7.65 (t, J=7.9 Hz, 2H), 7.88 (d, J=8.1 Hz, 2H), 8.47 (d, J=8.1 Hz, 2H); ¹³C NMR (150 MHz, CD₃OD): δ 123.7, 124.3 (d, J=2.1 Hz), 127.2 (d, J=2.2 Hz), 127.3, 127.7, 127.9, 128.6, 128.8, 128.9, 130.1, 135.7, 141.4, 141.5, 147.7 (d, J=9.8 Hz); ³¹P NMR (243 MHZ, CD₃OD): δ 3.2; HRMS calcd for [C₃₂H₂₁O₄P] ([M−H]⁺): 499.1104, found 499.1106.

### Example 11: Synthesis of 2,2′-biphenol Hydrogen Phosphate

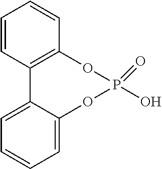 [SMILES: O=P1(O)Oc2ccccc2-c2ccccc2O1]

In a glove box filled with nitrogen, 2,2′-biphenol (0.36 mmol), diphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 uL toluene) and Et₃N (0.06 mmol) were sequentially added thereto. A resulting reaction mixture was stirred at 60° C. for 6 hours, then KOH (0.6 mmol) was added thereto and alkaline hydrolysis was continued at 80° C. for 3 hours. At the end of reaction, dichloromethane and a 4 M dilute hydrochloric acid solution were added and subjected to acidification until a resulting acidification system had a pH of 2, and a resulting organic phase was extracted several times. A resulting combined organic phases were evaporated to dryness on a rotary evaporator and then a resulting crude reaction mixture was purified by flash chromatography to obtain a product in 89% yield (yield calculated on phosphorus atoms).

Main NMR data: ¹H NMR (600 MHZ, CD₃OD): δ 7.29 (d, J=8.0 Hz, 2H), 7.39 (t, J=7.5 Hz, 2H), 7.48 (d, J=7.5 Hz, 2H), 7.60-7.61 (m, 2H); ¹³C NMR (150 MHz, CD₃OD): δ 122.5 (d, J=4.4 Hz), 127.3, 130.1, 130.9, 131.1, 149.8 (d, J=9.1 Hz); ³¹P NMR (243 MHZ, CD₃OD): δ 2.5; HRMS calcd for [C₁₂H₉O₄P] ([M−H]): 247.0165, found 247.0165.

### Example 12: Synthesis of 5,5′-diallyl-2,2′-biphenol Hydrogen Phosphate

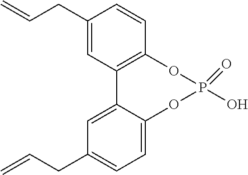 [SMILES: C=CCc1ccc2c(c1)-c1cc(CC=C)ccc1OP(=O)(O)O2]

In a glove box filled with nitrogen, 5,5′-diallyl-2,2′-biphenol (0.36 mmol), diphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 4 hours, then KOH (0.6 mmol) was added thereto and alkaline hydrolysis was continued at 80° C. for 3 hours. At the end of reaction, dichloromethane and a 4 M dilute hydrochloric acid solution were added and subjected to acidification until a resulting acidification system had a pH of 1, and a resulting organic phase was extracted several times. A resulting combined organic phases were evaporated to dryness on a rotary evaporator and then a resulting crude reaction mixture was purified by flash chromatography to obtain a product in 83% yield (yield calculated on phosphorus atoms).

Main NMR data: ¹H NMR (600 MHZ, CD₃OD): δ 3.47 (d, J=4.9 Hz, 4H), 5.08-5.14 (m, 4H), 5.98-6.04 (m, 2H), 7.20-7.39 (m, 6H); ¹³C NMR (150 MHz, CD₃OD): δ 40.4, 116.5, 122.3 (d, J=3.3 Hz), 129.8, 130.8, 131.2, 138.5, 139.8, 147.9 (d, J=9.7 Hz); ³¹P NMR (243 MHZ, CD₃OD): δ 2.6; HRMS calcd for [C₁₈H₁₇₀₄P] ([M−H]): 327.0791, found 327.0791.

### Example 13: Synthesis of 3,3′,5,5′-tetramethyl-2,2′-biphenol Hydrogen Phosphate

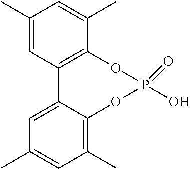 [SMILES: Cc1cc(C)c2c(c1)-c1cc(C)cc(C)c1OP(=O)(O)O2]

In a glove box filled with nitrogen, 3,3′,5,5′-tetramethyl-2,2′-biphenol (0.33 mmol), diphenyl disulfide (80 mol %, 0.24 mmol), and DMSO (3 mL) were sequentially placed in a 10 ml Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 4 hours, then KOH (0.6 mmol) was added thereto and alkaline hydrolysis was continued at 80° C. for 3 hours. At the end of reaction, dichloromethane and a 4 M dilute hydrochloric acid solution were added and subjected to acidification until a resulting acidification system had a pH of 3, and a resulting organic phase was extracted several times. A resulting combined organic phases were evaporated to dryness on a rotary evaporator and then a resulting crude reaction mixture was purified by flash chromatography to obtain a product in 88% yield (yield calculated on phosphorus atoms).

Main NMR data: ¹H NMR (600 MHZ, CD₃OD): δ 2.36 (s, 6H), 2.37 (s, 6H), 7.14 (s, 2H), 7.16 (s, 2H); ¹³C NMR (150 MHz, CD₃OD): δ 16.5, 20.9, 128.9, 130.0, 131.2 (d, J=3.8 Hz), 132.7, 136.7, 145.9 (d, J=9.5 Hz); ³¹P NMR (243 MHz, CD₃OD): δ 3.0; HRMS calcd for [C₁₆H₁₇O₄P] ([M−H]⁺): 303.0791, found 303.0793.

### Example 14: Synthesis of (S)-3,3′-dimethyl-1,1′-binaphthol Hydrogen Thiophosphate

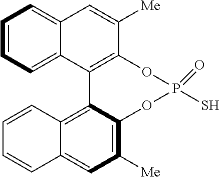

In a glove box filled with nitrogen, (S)-3,3′-dimethyl-[1,1′-binaphthylyl]-2,2′-diphenol (0.33 mmol), diphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 4 hours, then NaSH (0.6 mmol) was added thereto and reaction was continued at 80° C. for 3 hours. At the end of the reaction, dichloromethane and a 4 M dilute hydrochloric acid solution were added and subjected to acidification until a resulting acidification system had a pH of 3, and a resulting organic phase was extracted several times. A resulting combined organic phases were evaporated to dryness on a rotary evaporator and then a resulting crude reaction mixture was purified by flash chromatography to obtain a product in 90% yield (yield calculated on phosphorus atoms).

Main NMR data: ¹H NMR (500 MHz, CDCl₃): δ 2.42 (s, 3H), 2.54 (s, 3H), 7.06-7.16 (m, 4H), 7.28-7.36 (m, 2H), 7.46 (s, ¹H), 7.62 (d, J=8.2 Hz, ¹H), 7.72 (s, ¹H), 7.77 (d, J=8.4 Hz, ¹H); ¹³C NMR (125 MHZ, CDCl₃): δ 17.8, 18.4, 122.3, 122.7, 125.37, 125.43, 125.51, 125.68, 126.8, 127.0, 127.7, 129.8, 130.3, 130.57, 130.60, 131.11, 131.16, 131.4, 131.6, 147.3 (d, J=9.7 Hz), 147.8 (d, J=12.7 Hz); ³¹P NMR (202 MHZ, CDCl₃): δ 65.0.

### Example 15: Synthesis of (R)-3,3′-diphenyl-1,1′-binaphthol Hydrogen Phosphate

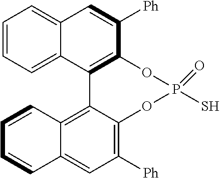

In a glove box filled with nitrogen, (R)-3,3′-diphenyl-[1,1′-binaphthylyl]-2,2′-diphenol (0.33 mmol), diphenyl disulfide (80 mol %, 0.24 mmol), and DMSO (3 mL) were sequentially placed in a 10 mL Schlenk tube with a stirrer. Then a white phosphorus-toluene solution (9.3 mg P₄, 0.3 mmol P-atom, dissolved in 320 μL toluene) and Et₃N (0.06 mmol) were sequentially added thereto. A resulting reaction mixture was stirred at 80° C. for 5 hours, then NaSH (0.6 mmol) was added thereto and alkaline hydrolysis was continued at 80° C. for 3 hours. At the end of reaction, dichloromethane and a 4 M dilute hydrochloric acid solution were added and subjected to acidification until a resulting acidification system had a pH of 1, and a resulting organic phase was extracted several times. A resulting combined organic phases were evaporated to dryness on a rotary evaporator and then a resulting crude reaction mixture was purified by flash chromatography to obtain a product in 89% yield (yield calculated on phosphorus atoms).

Main NMR data: ¹H NMR (500 MHz, CDCl₃): δ 7.11-7.52 (m, 14H), 7.63 (d, J=7.7 Hz, 2H), 7.85 (s, ¹H), 7.91 (d, J=8.3 Hz, 2H), 7.98 (s, ¹H), 8.01 (d, J=8.3 Hz, 2H); ¹³C NMR (125 MHz, CDCl₃): δ 123.6, 123.9, 125.7, 125.9, 126.3 126.6, 127.1, 127.3, 127.8, 128.3, 128.4, 128.5, 129.8, 130.4, 130.7, 131.1, 131.2, 131.5, 132.37, 132.41, 133.9, 134.8, 137.9, 138.5, 145.5 (d, J=9.3 Hz), 146.0 (d, J=13.7 Hz); ³¹P NMR (202 MHZ, CDCl₃): δ 62.6.

### INDUSTRIAL APPLICABILITY

The cyclic phosphate compounds containing a diaryl structural unit and derivatives thereof of the present disclosure have a wide range of applications as organophosphorus ligands in asymmetric catalysis.

What is claimed is:

1. A method for preparing a cyclic phosphate compound and a derivative thereof, the cyclic phosphate compound being a compound of formula (III) or a compound of formula (IV) each containing a diaryl structural unit, 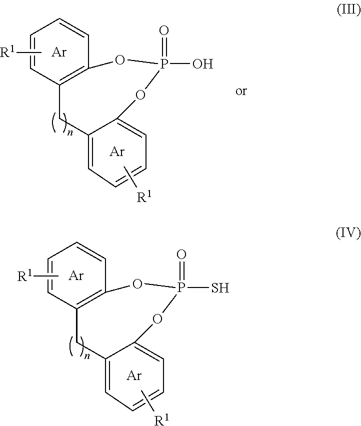
wherein in the formula (III) or the formula (IV), R¹ represents one selected from the group consisting of hydrogen, halogen, alkenyl, nitro, cyano, trifluoromethyl, trifluoromethoxy, alkyl, alkoxy, substituted or unsubstituted phenyl, substituted or unsubstituted biphenyl, naphthyl, anthracenyl, phenanthrenyl, pyridyl, thienyl, and a benzo group; Ar represents one selected from the group consisting of phenyl, naphthyl, anthracenyl, phenanthrenyl, pyridyl, and thienyl; and n represents carbon number and is an integer of 0 or greater than 0; and
the method comprising: 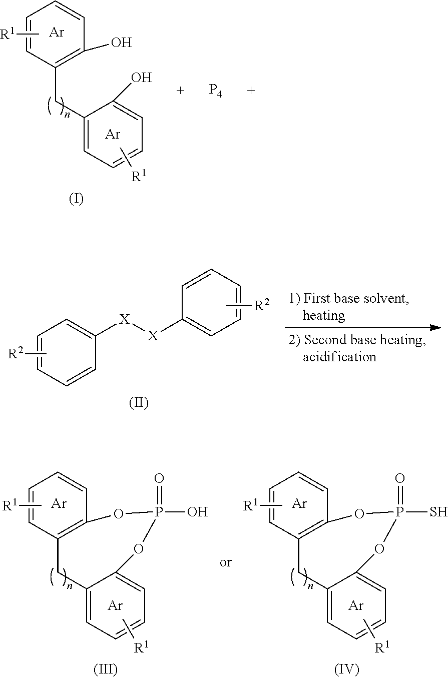
step 1) adding a compound of formula (I), a compound of formula (II), and a solvent to a reactor, and then adding white phosphorus and a first base in sequence, followed by heating while stirring to obtain a mixed solution of reactants;
and step 2) adding a second base to the mixed solution of reactants obtained in step 1), and subjecting a resulting mixture to heating and reaction; at end of the reaction, stopping the heating and then cooling a resulting reaction product to room temperature; and adding an acid to the reactor and conducting acidification to obtain the compound of formula (III) or the compound of formula (IV),
wherein in the formula (I) and the formula (II), R¹ and R² independently represent one selected from the group consisting of hydrogen, halogen, alkenyl, nitro, cyano, trifluoromethyl, trifluoromethoxy, alkyl, alkoxy, substituted or unsubstituted phenyl, substituted or unsubstituted biphenyl, naphthyl, anthracenyl, phenanthrenyl, pyridyl, and thienyl; Ar in the formula (I) represents one selected from the group consisting of phenyl, naphthyl, anthracenyl, phenanthrenyl, pyridyl, and thienyl; n in the formula (I) represents carbon number and is an integer of 0 or greater than 0; and X in the formula (II) represents one selected from the group consisting of S, Se, and Te.

2. The method of claim 1, wherein in step 1), the first base is selected from the group consisting of a hydroxide, a carbonate, a phosphate or an organic alkoxide of an alkali metal, and an organic amine.

3. The method of claim 1, wherein in step 1), the heating is conducted at a temperature of 40° C. to 120° C. for 2 hours to δ hours.

4. The method of claim 1, wherein in step 1), a molar amount of the compound of formula (I) is 1.0 time to 1.5 times a molar equivalent of phosphorus atoms in the white phosphorus, a molar amount of the compound of formula (II) is 0.2 times to 2.0 times the molar equivalent of the phosphorus atoms in the white phosphorus, and a molar amount of the first base is 0.2 times to 2.0 times the molar equivalent of the phosphorus atoms in the white phosphorus.

5. The method of claim 1, wherein in step 2),
under a condition for synthesis of the compound of formula (III), the second base is selected from the group consisting of a hydroxide, a carbonate, a phosphate or an organic alkoxide of an alkali metal, and an organic amine; and
under a condition for synthesis of the compound of formula (IV), the second base is selected from the group consisting of sodium hydrosulfide, potassium hydrosulfide, sodium sulfide, and ammonium sulfide.

6. The method of claim 1, wherein in step 2), the acid used for the acidification is a strong inorganic acid, and the acidification is conducted until a resulting acidification system has a pH of 1 to 3.

7. The method of claim 1, wherein in step 2), after adding the second base, the reaction is conducted at a temperature of 120° C. for 1 hour to 8 hours.

8. The method of claim 1, wherein in step 2), a molar amount of the second base is 1.0 time to 2.5 times a molar equivalent of phosphorus atoms in the white phosphorus.
